(19) United States
(12) Patent Application Publication
(10) Pub. No.: US 2011/0030234 A1
(43) Pub. Date: Feb. 10, 2011

(54) Clothes Dryer Having Liquid Injection Nozzle

(76) Inventors: Soowon Park, Changwon (KR); Sanghun Bae, Changwon (KR); Minji Kim, Changwon (KR)

Correspondence Address: MCKENNA LONG & ALDRIDGE LLP, 1900 K STREET, NW, WASHINGTON, DC, 20006, US

(21) Appl. No.: 12/846,469

(22) Filed: Jul. 29, 2010

Related U.S. Application Data
(60) Provisional application No. 61/213,955, filed on Jul. 31, 2009.

(30) Foreign Application Priority Data
Jul. 31, 2009 (KR) 10-2009-0070970

(51) Int. Cl. F26B 19/00

(52) U.S. Cl. 34/90

(57) ABSTRACT

Disclosed is a clothes dryer including a cabinet, a drum rotatably installed in the cabinet, an inlet disposed at an upper side of a rear surface of the drum, and allowing air to be introduced therethrough, an outlet disposed at a lower side of a front surface of the drum, and allowing air to be discharged out therethrough, and a nozzle installed at the rear surface of the drum and configured to inject liquid, wherein an injection region of the nozzle is present below a line connecting the nozzle and the outlet, whereby the outlet of air discharged out of the drum is not present within the injection region in which the liquid is injected via the nozzle, so as to prevent the liquid injected via the nozzle from being discharged out of the outlet and also overcome a problem occurred due to remnant ingredients of the injected liquid remaining on a filter located at the outlet of the drum.

### CROSS-REFERENCE TO RELATED APPLICATION

Pursuant to 35 U.S.C. §119(a), this application claims the benefit of earlier filing date and right of priority to Korean Application No. 10-2009-0070970, filed on Jul. 31, 2009, and U.S. Patent Application No. 61/213,955 filed on Jul. 31, 2009, the contents of which is incorporated by reference herein in its entirety.

### BACKGROUND OF THE INVENTION

1. Field of the Invention

The present invention relates to a clothes dryer having an injection nozzle capable of injecting liquid into a drum, and particularly, to a clothes dryer having an injection nozzle capable of injecting liquid into a drum of the clothes dryer via the injection nozzle.

2. Background of the Invention

In general, a clothes dryer is a device for inputting the laundry in a spin-dry-terminated state after washing is completed into the interior of a drum and supplying hot wind into the drum to evaporate moisture of the laundry to thus dry the laundry.

The clothes dryer includes a drum into which the laundry is input, a driving motor for driving the drum, a blow fan for blowing air into the interior of the drum, and a heating unit for heating air introduced into the interior of the drum. The heating unit may use high temperature electric resistance heat generated by using an electric resistance or combustion heat generated by combusting (burning) gas.

Air discharged from the drum in the clothes dryer contains moisture of the laundry placed within the drum, so the air includes much moisture and has a high temperature. In this case, the dryer may be classified into according to how the air with much moisture at a high temperature is processed. Namely, the driver may be classified into a condense type drier in which air with high temperature and high moisture is circulated, rather than being discharged to the outside, to be heat exchanged with external air in a condenser to condense the moisture contained in the air with the high temperature and high moisture, and an exhaust type dryer in which air with the high temperature and high moisture, which has passed through the drum, is directly discharged outwardly.

However, as users take different lift styles, demands on clothes dryers having various functions in addition to the drying function increase. For instance, the tendency is to release clothes dryers having various functions for maintaining and preserving the laundry as well as drying the same, such as removing wrinkles on the laundry using a rotational force of the drum in the clothes dryer and separate additives, spraying fragrance, handling static electricity and the like.

In addition, clothes dryers for adding fragrance to the laundry by supplying a material with a specific fragrance upon drying the laundry have been introduced. In the clothes dryers, the odor of the laundry which may remain in the laundry after being dried is removed and new fragrance is added to the laundry.

To this end, a clothes dryer having an injection nozzle through which a fragrance liquid is injected into the drum has been produced; however, since the strength of fragrance and an amount of a fragrance material consumed depend on how to inject fragrance, an injection module control method for controlling fragrance to be effectively deposited onto the clothes has been required.

Furthermore, the related art clothes dryer has employed a mechanism to drive a drum and a blow fan by using a single driving motor. That is, a power transfer belt for driving the drum is connected to a pulley formed at one side of the driving motor and a driving shaft of the blow fan for driving the blow fan is connected to another side of the driving motor, so when the driving motor rotates, the drum and the blow fan cooperatively rotate at the same time. Due to this configuration, if liquid is injected into the drum, no mechanism has not been given to independently control the rotation of the drum and the blow fan, accordingly, there are limitations in urging the injected liquid effectively deposited onto the clothes.

When the liquid injected into the drum is a fragrance material, the loss amount that the fragrance injected into the drum is discharged out of the drum without being deposited on the clothes should be minimized. Especially, if the injected fragrance into the drum is discharged via a filter disposed at a lower side of a front surface of the drum, the ingredients remaining at the filter after the fragrance is completely evaporated are stuck on a mesh of the filter, thereby lowering the performance of the filter, consequently, causing the entire performance of the dryer to be lowered.

### SUMMARY OF THE INVENTION

Therefore, to overcome the problems of the related art, an object of the present invention is to provide a clothes dryer having an injection nozzle capable of effectively injecting liquid into a drum of the dryer.

Another object of the present invention is to provide a clothes dryer capable of preventing liquid injected via the injection nozzle from flowing toward a filter.

To achieve these and other advantages and in accordance with the purpose of the present invention, as embodied and broadly described herein, there is provided a clothes dryer including a drum rotatably installed in a main body defining an outer appearance, an inlet disposed at an upper side of a rear surface of the drum, and allowing air to be introduced therethrough, an outlet disposed at a lower side of a front surface of the drum, and allowing air to be discharged out therethrough, and a nozzle installed at the rear surface of the drum and configured to inject liquid, wherein an injection region of the nozzle is present below a line connecting the nozzle and the outlet.

With the configuration, since the outlet of air discharged out of the drum is not present within the injection region in which the liquid is injected via the nozzle, a speed that the liquid injected via the nozzle is discharged out via the outlet of the drum can be delayed, thereby allowing the liquid to remain longer within the drum.

An outlet of the nozzle through which the liquid is injected may preferably be in a concaved shape concaved more than a periphery thereof. Such structure is derived because the outlet of the nozzle may be damaged due to being bumped against the laundry within the drum if the same protrudes more than its periphery.

A discharge passage of the nozzle may be installed to form an angle of 35° from a longitudinal axis of the dryer main body, and an injection angle at which fragrance is injected via the nozzle may be 45°.

Also, the nozzle may be installed at the rear surface of the drum to be higher than the inlet, and the clothes dryer may further include a cartridge installed at an upper surface of the main body and containing the liquid to be injected into the drum, and a pump disposed between the cartridge and the nozzle and configured to press the liquid.

The clothes dryer may further include a driving motor configured to drive the drum, and a fan motor configured to drive a blow fan, which allows flow of air introduced into the drum, wherein the driving motor and the fan motor can be controlled independent of each other, accordingly, the drum rotates while the blow fan is suspended when the liquid is injected via the nozzle.

With the configuration of the present invention, the liquid injected via the injection nozzle can effectively be deposited on the laundry within the drum without being lost due to being discharged through a filter.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a clothes dryer in accordance with one embodiment of the present invention;

FIG. 2 is a longitudinal sectional view showing an interior of the clothes dryer of FIG. 1;

FIG. 3 is a view showing a state that a liquid is injected into a drum in the clothes dryer according to the present invention; and

FIG. 4 is a sectional view of the injection nozzle mounted to a rear surface of the drum in the clothes dryer of FIG. 3.

### DETAILED DESCRIPTION OF THE INVENTION

Description will now be given in detail of a configuration of a clothes dryer and a fragrance injection nozzle in accordance with the preferred embodiments of the present invention, with reference to the accompanying drawings.

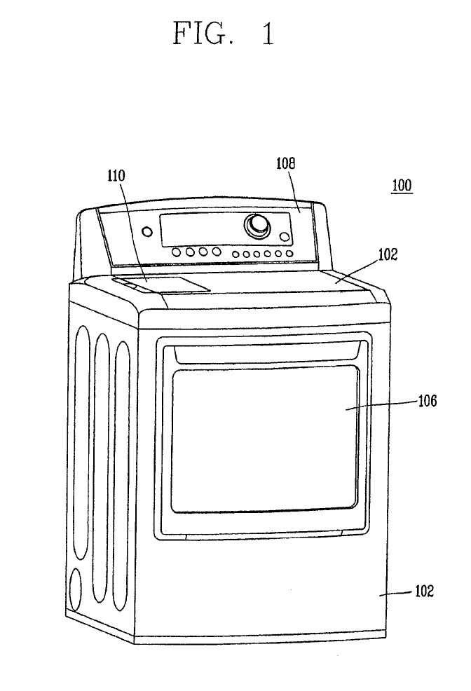

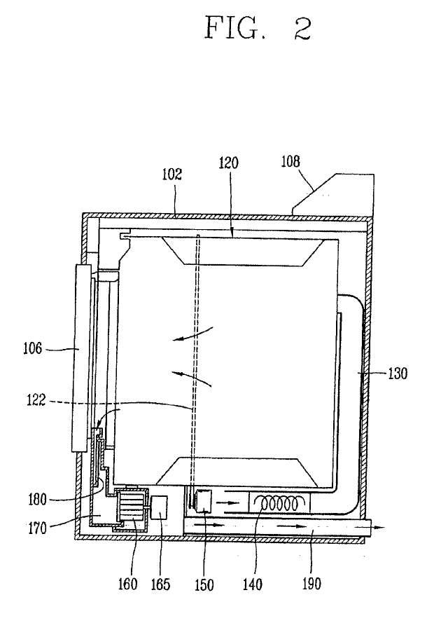

FIG. 1 is a perspective view schematically showing a clothes dryer in accordance with one embodiment of the present invention, and FIG. 2 is a sectional view showing schematically showing an internal structure of FIG. 1.

As shown in FIGS. 1 and 2, a dryer 100 may include a cabinet defining an outer appearance of the device, and the front surface of the cabinet is shown having an opening open and closed by a door 106 for inputting the laundry to be dried thereinto. A manipulation panel 108 having various manipulation buttons for manipulating the dryer 100 may be present on a rear side of an upper surface of the dryer. Here, the present invention may not be limited only to the dryer, but be applicable to any clothes processing device having a drying function, for instance, a washing machine having the drying function or the like.

Meanwhile, a cartridge mounting unit 110 is disposed at an upper surface 102 of a dryer main body, and a cartridge (not shown) containing liquid may be replaceably mounted in the cartridge mounting unit 110. The liquid stored in the cartridge may be injected into a drum in a form of mist. The stored liquid may be water or a fragrance liquid which is a material having fragrance in a liquid state. The fragrance liquid mostly consists of water and is a mixture in which a fragrance undiluted solution is mixed at the preset rate. The liquid stored in the cartridge may be supplied to a nozzle disposed at a rear surface of the drum so as to be injected into the drum via the nozzle. For this, a pump for pressing the flowing liquid may be provided between the cartridge and the nozzle. If the liquid stored in the cartridge is water, the water is sprayed into the drum, and if the liquid is a fragrance solution, the fragrance solution is injected into the drum.

The dryer 110, as a clothes treating apparatus according to the present invention, may include a drum 120 rotatably installed in the cabinet for drying the laundry therein. The drum 120 may be rotatably supported by supporters at front and rear sides. In addition, the drum 120 may be connected to a driving motor 150 disposed at a lower side of the dryer so as to receive a rotational force. An inlet duct 130 may be installed at the rear side of the drum 120, and a heater 140 for heating an introduced air may be installed at an inlet side of the inlet duct 130. The front lower side of the drum 120 is shown, having a filter 180 for filtering out foreign materials, such as lint or the like, included in air discharged out of the drum 120, and ducts 170 and 190 for completely discharging the foreign material-filtered air to the exterior.

The ducts 170 and 190 may include a blow fan 160 for sucking up air within the drum 120 to forcibly blow out of the dryer, and a fan motor 165 for driving the blow fan 160. The present invention is characterized by a two-motor system separately having the driving motor 150 for driving the drum 120, and the fan motor 165 for driving the blow fan 160, so the two motors can be independently controlled. Consequently, the present invention may have an advantage of independently rotating the drum 120 and the blow fan 160. In other words, in the two-motor system, only the rotation of the drum 120 other than that of the blow fan 160 is allowed while a liquid is injected, accordingly, the liquid can be injected in a state that no air flows within the drum 120, thereby enabling a more effective deposition of the liquid into the laundry.

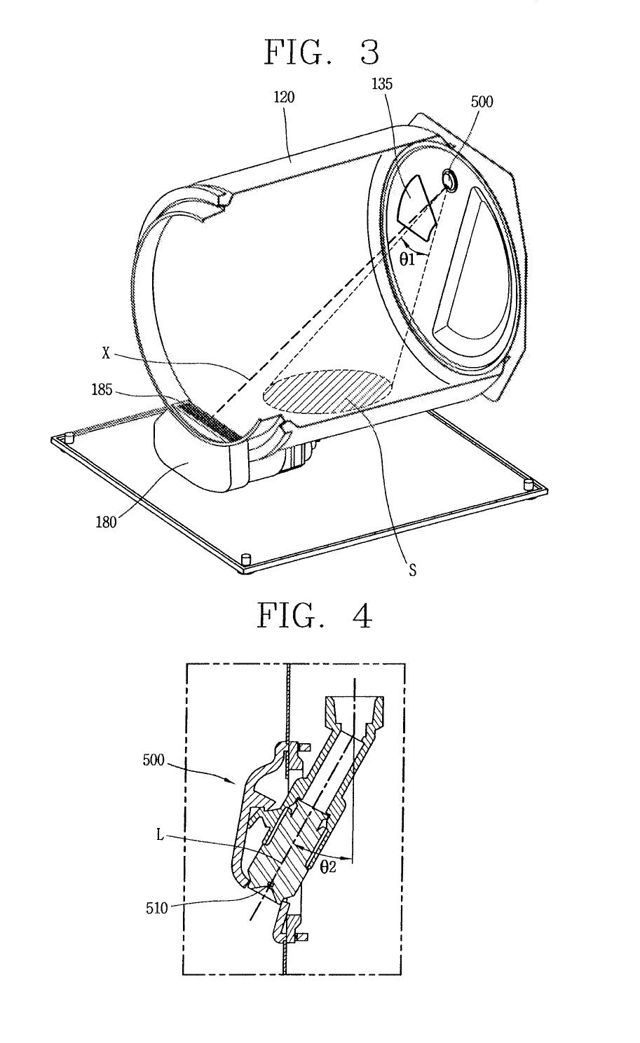

FIG. 3 is a view showing that a liquid is injected into the drum in the clothes dryer according to the present invention, and FIG. 4 is a sectional view of a nozzle 500 mounted to the rear surface of the drum in the clothes dryer of FIG. 3.

Referring to FIGS. 3 and 4, an inlet 135 through which air is introduced may be formed at an upper side of the rear surface of the dryer drum 120, and an outlet 185 through which air containing moisture present within the laundry is discharged out of the drum 120. Air heated up by a heating unit is introduced into the inlet 135 and thereafter absorbs moisture contained in the laundry within the drum 120 so as to be discharged out via the outlet 185. Also, the filter 180 for filtering out foreign materials, such as lint or the like, included in the discharged air, is disposed at a lower side of the outlet 185.

A nozzle 500 according to the present invention may be installed at an upper side of the rear surface of the drum 120 in the clothes dryer. If water is stored in the cartridge for storing a liquid, the water is injected via the nozzle 500 of a liquid injection module, and if a fragrance liquid is stored in the cartridge, the fragrance is injected via the nozzle 500. The liquid is injected with a preset angle from an outlet of the nozzle 500, and hereinafter, the angle at which the liquid is sprayed out of the outlet of the nozzle 500 is referred to as ‘injection angle.’ If the injection angle is great, the liquid may be sprayed into a larger area, and if small, the liquid may be sprayed within a small range so as to be concentrated within a specific range. The injection angle may be determined according to an internal pressure or an internal structure of the nozzle 500, and be set such that fragrance can be injected at an injection angle desired by a user. This embodiment has set the injection angle θ1 to 45°.

In addition, a region in which the fragrance liquid injected via the nozzle at the specific injection angle θ1 reaches an inner circumferential surface of the drum 120 is referred to as ‘injection region S.’ However, the outlet 185 through which air is discharged out of the drum 120 may preferably be located outside the injection region. As aforesaid, the filter 180 is generally disposed at the outlet present at the lower side of the front surface of the drum 120, so as to filter out foreign materials, such as lint or the like, contained in the air discharged out of the drum 120. The filter 180 may include a mesh portion with small holes for filtering out the foreign materials, so the foreign materials contained in the air passing through the mesh portion can be filtered out thereby. However, if the liquid injected into the drum 120 flows through the filter 180, the injected liquid may be disadvantageously lost. Furthermore, if a fragrance liquid is injected via the nozzle 500, the injected fragrance liquid is stuck in the filter. Accordingly, after moisture is completely evaporated from the fragrance liquid, the remnant fragrance material may block the inside or the mesh of the filter 180, which may cause the performance of the filter 180 to be lowered and an amount of air passing through the filter 180 to be reduced, thereby lowering the entire performance of the clothes dryer. Hence, it is important to prevent the injected fragrance via the nozzle from being introduced into the air outlet of the drum 120. For this, the present invention has been designed such that the outlet is not located within the injection region in which the liquid is injected. That is, the outlet of the nozzle 500 is allowed to face the lower side of the drum 120, accordingly, the nozzle 500 has been installed such that the injection region is present below a line connecting the nozzle 500 and the outlet. Referring to FIG. 4 showing the section of the nozzle 500, an outlet 510 of the nozzle 500 is in a concaved shape that a central portion is concaved more than its periphery. If the central portion of the nozzle 500 protrudes more than the periphery, it may bump against the laundry within the drum 120 so as to be damaged. In addition, the nozzle 500 may have a passage, from a preset point within the nozzle 500 to the outlet 510 of the nozzle 500, within which the liquid straightly flows. The passage, within which the injected liquid straightly flows before reaching the outlet 510 of the nozzle 500, is referred to as ‘injection passage L.’ An angle formed between the injection passage and a longitudinal axis of the clothes dryer is referred to as an installation angle θ2 of the nozzle 500. This embodiment has set the installation angle of the nozzle 500 to 35° in order to prevent the outlet of the drum 120 from being located within the injection region. Also, the nozzle may preferably be installed at the rear surface of the drum to be higher than the inlet through which hot wind is introduced.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A clothes dryer comprising:
a cabinet;
a drum rotatably installed in the cabinet;
an inlet disposed at an upper side of a rear surface of the drum, and allowing air to be introduced therethrough;
an outlet disposed at a lower side of a front surface of the drum, and allowing air to be discharged out therethrough; and
a nozzle installed at the rear surface of the drum and configured to inject liquid,
wherein an injection region of the nozzle is present below a line connecting the nozzle and the outlet.

2. The clothes dryer of claim 1, wherein an outlet of the nozzle through which the liquid is injected is in a concaved shape more concaved than the periphery thereof.

3. The clothes dryer of claim 2, wherein the nozzle is installed such that a discharge passage of the nozzle forms an angle of 35° from a longitudinal axis.

4. The clothes dryer of claim 2, wherein an injection angle at which the liquid is injected via the nozzle is 45°.

5. The clothes dryer of claim 1, wherein the nozzle is installed at the rear surface of the drum to be higher than the inlet.

6. The clothes dryer of claim 1, further comprising:
a cartridge installed at an upper surface of the cabinet and containing the liquid to be injected into the drum; and
a pump disposed between the cartridge and the nozzle and configured to press the liquid.

7. The clothes dryer of claim 1, further comprising:
a driving motor configured to drive the drum; and
a fan motor operating independent of the driving motor and configured to drive a blow fan, the blow fan allowing flow of air introduced into the drum.

8. The clothes dryer of claim 7, wherein fragrance is injected via the nozzle in a suspended state of the blow fan.
